(19) United States
(12) Patent Application Publication
(10) Pub. No.: US 2008/0162794 A1
(43) Pub. Date: Jul. 3, 2008

(54) Disk Array System Composed Of Solid State Memory Subsystems

(76) Inventor: Chih-Yi Yang, Taipei City (TW)

Correspondence Address: HDSL, 4331 STEVENS BATTLE LANE, FAIRFAX, VA, 22033, US

(21) Appl. No.: 11/962,217

(22) Filed: Dec. 21, 2007

(30) Foreign Application Priority Data
Dec. 28, 2006 (TW) 095149483

(51) Int. Cl. G06F 12/00; G06F 12/02

(52) U.S. Cl. 711/103; 711/114; 711/E12.001; 711/E12.008

(57) ABSTRACT

A disk array system using solid state memory as storage media includes a controller and a plurality of memory subsystems electrically connected with the controller. The memory subsystem adopts RAID structure. Each of the memory subsystems is composed of a control unit and a plurality of solid state memories such as flash memories. The flash memories are controlled by the control unit to be an integrated memory with accumulative memory capacity. The memory subsystem has an IDE or SATA connecting interface to simulate a single hard disk drive. The memory subsystems associate the controller to constitute the disk array system.

### BACKGROUND OF THE INVENTION

1. Field of the Invention

This invention relates to the field of disk array. More specially, this invention relates to a disk array using solid state hard disk drives.

2. Background Art

Due to the wide application of computer servers, the markets require a storage device with high security, high capacity and high speed. Thus, the disk array systems become a best choice for this requirement of storage device.

Up to the present, almost all the disk array systems in the markets follow the RAID (Redundant Arrays of Inexpensive Disks) specification defined by the RAID Advisory Board. The disk array systems with different RAID levels can be applied in different circumstances. In general, the disk array systems are to provide a kind of data storage equipment with high capacity and high efficiency. Meanwhile, the disk array systems can also improve the security of data stored therein. The structure of a disk array system is composed of a plurality of independently actual hard disk drives to constitute a virtually single disk drive with accumulative memory capacity by means of a controller integratedly controlling the read/write actions of the hard disk drives and integratedly managing the memory space.

The hard disk drives used in the disk array systems are a mechanical structure using reciprocation of the head and rotation of the disk to make the head read or write data on the disk. Those conventionally mechanical hard disk drives rely on accurate cooperation of the head and disk, so they need longer access time to read or write data. That results in a bottleneck of quickening read/write speed. According to present technology, to speed up the access time of hard disk drive the primary solution is increasing the rotation speed of disk to compensate the lag of access time. Increasing rotation speed, however, will invite another serious problem of high heat and vibration. Undue heat is an excess load of the heat dissipation of the computer system. Vibrated circumstances are very disadvantageous to modern high-density hard disk drives. Additionally, the mechanical hard disk drives tend to be frozen in the circumstances with low temperature. That may affect the rotation of disk or even cause breakdown. Therefore, conventional hard disk drives are hardly used in the circumstances with unduly high or low temperature or vibration.

### SUMMARY OF THE INVENTION

It is a primary object of the present invention to provide a disk array system composed of solid state memory subsystems which quickens access time of data read/write and can be used in hard circumstances such as unduly hot or cold or vibrated.

The above object is accomplished in accordance with the present invention which provides a disk array system using solid state memory, such as flash memory, as storage media. The disk array includes a controller and a plurality of memory subsystems electrically connected with the controller. The memory subsystem adopts RAID structure. Each of the memory subsystems is composed of a control unit and a plurality of solid state memories such as flash memories. The flash memories are controlled by the control unit to be an integrated memory with accumulative memory capacity. The memory subsystem has an IDE or SATA connecting interface to simulate a single hard disk drive. The memory subsystems associate the controller to constitute the disk array system.

### BRIEF DESCRIPTION OF THE DRAWINGS

The following detailed description, given by way of example and not intended to limit the present invention solely thereto, will best be understood in conjunction with the accompanying drawings, in which:

FIG. 1 schematically illustrates a systematic structure of the present invention; and

FIG. 2 schematically illustrates a systematic structure of a memory subsystem of the present invention.

### DETAILED DESCRIPTION OF THE INVENTION

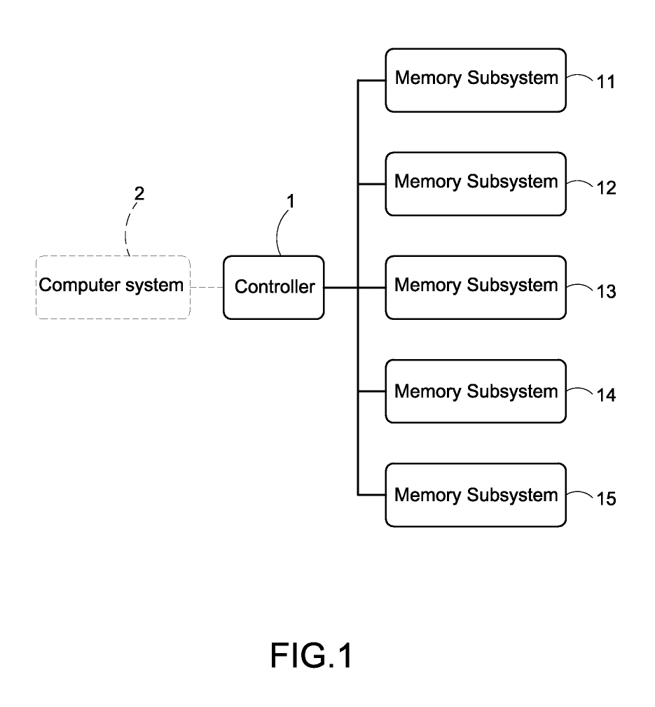

FIG. 1 is a block diagram illustrating a systematic structure of an embodiment of the present invention. As shown in FIG. 1, a disk array system includes a controller 1, which can be electrically connected with a computer system 2 for providing data access. The controller 1 has a built-in software to perform data processing and integrating actions. The controller 1 electrically connects a plurality of memory subsystems 11-15. Each of the memory subsystems 11-15 can receive data write-in or read-out commands transmitted from the controller 1. When the controller 1 receives the commands or data from the computer system 2, the software built in the controller 1 will integrate all the memory subsystems 11-15, so that the computer system 1 can write data in or read data out of the memory subsystems 11-15.

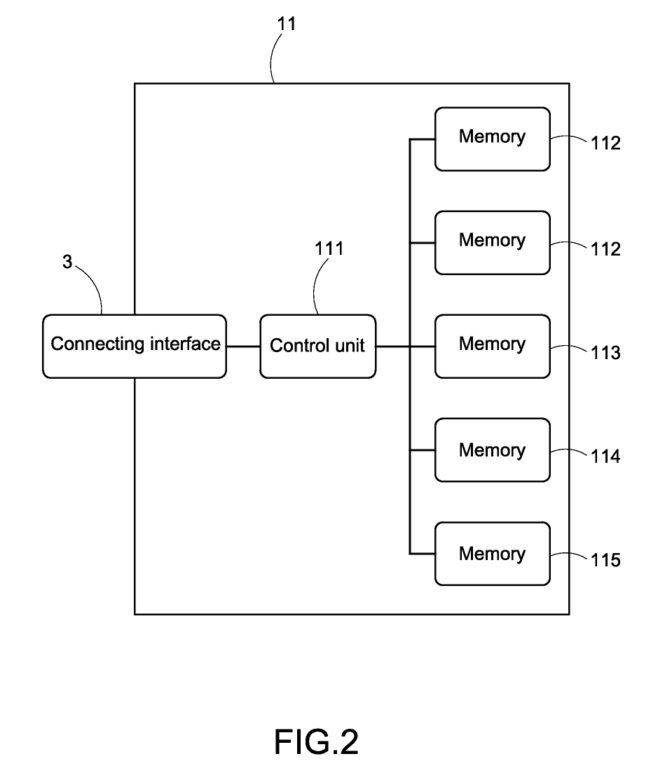

FIG. 2 shows a block diagram of one of the memory subsystems 11-15. Each memory subsystem 11-15 is constituted by the RAID structure. As shown in FIG. 2, the memory subsystem 11 includes a control unit 111. The control unit 111 also has a built-in software for integrating data and commands received. The control unit 111 electrically connects to the controller 1 through a connecting interface 3, which functions as a path of information delivery. The connecting interface 3 can be Series Advanced Technology Attachment (SATA) or conventionally parallel ATA standard. The control unit 111 electrically connects to a plurality of memories 112-115. The memories 112-115 are non-volatile solid state memories, such as flash memories. The memory subsystem 11 can simulate a single hard disk drive by the combination of the control unit 111, connecting interface 3 and memories 112-115. Thereby, data to be written in the memory subsystems 11-15 are managed by the controller 1 to be sent to the control unit 111 in the memory subsystem 11 through the connecting interface 3. Then the data are managed by the control unit 111 to be stored in the memories 112-115. Because a solid state memory has no mechanical elements, data stored in a disk array system in accordance with the present invention can be faster to access and safer to store.

While the invention is described and disclosed in connection with a certain preferred embodiment, it is not intended to limit the invention to the specific embodiment. Rather it is intended to cover all such alternative embodiments and modifications as fall within the spirit and scope of the invention.

What is claimed is:

1. A disk array system comprising:
a plurality of memory subsystems, wherein each of the memory subsystems comprises:
a plurality of solid state memories for storing data;
a control unit electrically connected to the solid state memories for integrating the solid state memories into a single memory unit and controlling data access of the solid state memories; and
a connecting interface electrically connected to the control unit for being a path of data delivery;
wherein the solid state memories and the connecting interface are controlled by the control unit to make the memory subsystem simulate a single hard disk drive; and
a controller electrically connected to the connecting interfaces of the respective memory subsystems for integrating and controlling data access of the memory subsystems by means of Redundant Arrays of Inexpensive Disks (RAID) structure.

2. The disk array system as in claim 1, wherein each of the memory subsystems uses the RAID structure.

3. The disk array system as in claim 1, wherein each of the connecting interfaces uses Series Advanced Technology Attachment (SATA) standard.

4. The disk array system as in claim 1, wherein each of the connecting interfaces uses parallel Advanced Technology Attachment (PATA) standard.

5. The disk array system as in claim 1, wherein the solid state memories are flash memories.
